(19) United States
(12) Patent Application Publication
(10) Pub. No.: US 2010/0211322 A1
(43) Pub. Date: Aug. 19, 2010

(54) INTERPOLATING A PRESSURE WAVEFIELD ALONG AN UNDERSAMPLED DIRECTION

(76) Inventors: Massimiliano Vassallo, Brighton (GB); Dirk-Jan Manen, Surrey (GB); Ali Ozbek, Cambridge (GB); Ahmet Kemal Ozdemir, Asker (NO)

Correspondence Address: WesternGeco L.L.C.;Kevin McEnaney, IP Dept, 10001 Richmond Avenue, HOUSTON, TX, 77042-4299, US

(21) Appl. No.: 12/370,762

(22) Filed: Feb. 13, 2009

(51) Int. Cl. G01V 1/28

(52) U.S. Cl. 702/14

(57) ABSTRACT

A technique includes receiving seismic data acquired in a seismic survey. The survey has an associated undersampled direction, and the seismic data contains samples, which are indicative of a pressure wavefield and a directional derivative of the pressure wavefield that contains information related to vertical variations. The technique includes relating the samples to the pressure wavefield or to the directional derivative of the pressure wavefield using at least one linear filter and based on the relationship, constructing a substantially unaliased continuous representation of the pressure wavefield or the directional derivative of the pressure wavefield along the undersampled direction.

### BACKGROUND

The invention generally relates to interpolating a pressure wavefield in an undersampled direction.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes receiving seismic data acquired in a seismic survey. The survey has an associated undersampled direction, and the seismic data contain samples, which are indicative of a pressure wavefield and a directional derivative of the pressure wavefield, which contains information related to vertical variations. The technique includes relating the samples to the pressure wavefield or to the directional derivative of the pressure wavefield using at least one linear filter; and based on the relationship, constructing a substantially unaliased continuous representation of the pressure wavefield or the directional derivative of the pressure wavefield along the undersampled direction.

In another embodiment of the invention, a system includes an interface and a processor. The interface receives seismic data acquired in a seismic survey. The survey has an associated undersampled direction, and the seismic data contain samples, which are indicative of a pressure wavefield and a directional derivative of the pressure wavefield, which contains information related to vertical variations. The processor processes the seismic data using at least one linear filter and, based on a relationship of the samples to the pressure wavefield or to the directional derivative of the pressure wavefield, the processor constructs a substantially unaliased continuous representation of the pressure wavefield or the directional direction of the pressure wavefield along the undersampled direction.

Advantages and other features of the invention will become apparent from the following drawing, description and claims.

### BRIEF DESCRIPTION OF THE DRAWING

FIG. 1 is a schematic diagram of a marine seismic acquisition system according to an embodiment of the invention.

FIG. 2 is an illustration of a generalized sampling expansion technique according to an embodiment of the invention.

FIGS. 3, 4 and 5 are flow diagrams depicting techniques to interpolate a pressure wavefield along a crossline direction according to embodiments of the invention.

FIG. 6 is a schematic diagram of a processing system according to an embodiment of the invention.

### DETAILED DESCRIPTION

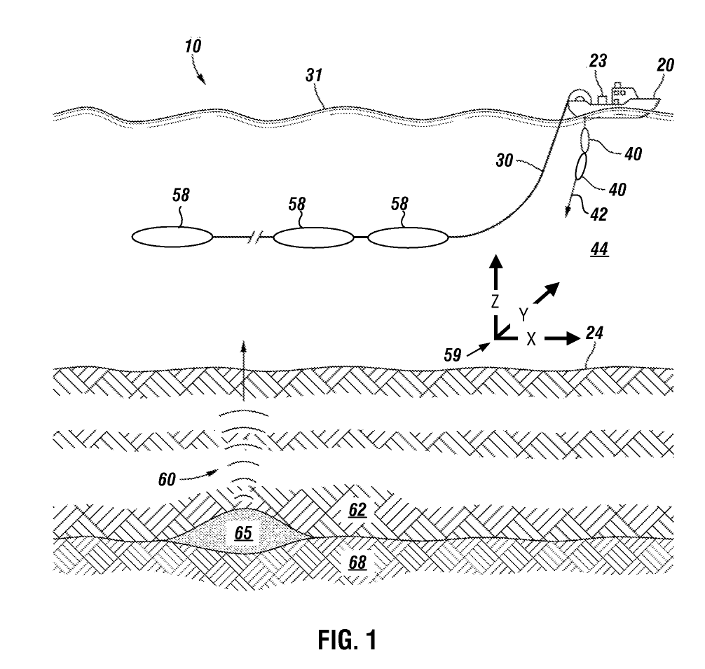

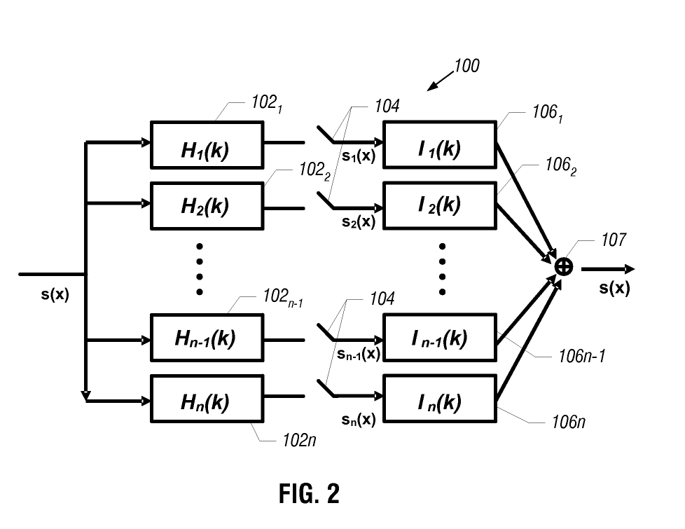

FIG. 1 depicts an embodiment 10 of a marine-based seismic data acquisition system in accordance with some embodiments of the invention. In the system 10, a survey vessel 20 tows one or more seismic streamers 30 (one exemplary streamer 30 being depicted in FIG. 1) behind the vessel 20. It is noted that the streamers 30 may be arranged in a spread in which multiple streamers 30 are towed in approximately the same plane at the same depth. As another non-limiting example, the streamers may be towed at multiple depths, such as in an over/under spread, for example.

The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensors that record seismic signals. The streamers 30 contain seismic sensors 58, which may be, depending on the particular embodiment of the invention, hydrophones (as one non-limiting example) to acquire pressure data or multi-component sensors. For embodiments of the invention in which the sensors 58 are multi-component sensors (as another non-limiting example), each sensor is capable of detecting a pressure wavefield and at least one component of a particle motion that is associated with acoustic signals that are proximate to the sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the multi-component seismic sensor may include one or more hydrophones, geophones, particle displacement sensors, particle velocity sensors, accelerometers, pressure gradient sensors, or combinations thereof.

For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the sensor. It is noted that the multi-component seismic sensor may be implemented as a single device (as depicted in FIG. 1) or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, at a particular point, seismic data indicative of the pressure derivative with respect to the inline direction, and another one of the pressure gradient sensors may acquire, at a particular point, seismic data indicative of the pressure derivative with respect to the vertical direction.

The marine seismic data acquisition system 10 includes seismic sources 40 (two exemplary seismic sources 40 being depicted in FIG. 1), such as air guns and the like. In some embodiments of the invention, the seismic sources 40 may be coupled to, or towed by, the survey vessel 20. Alternatively, in other embodiments of the invention, the seismic sources 40 may operate independently of the survey vessel 20, in that the sources 40 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic sources 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are created by the sources 40 produce corresponding reflected acoustic signals, or pressure waves 60, which are sensed by the seismic sensors 58. It is noted that the seismic waves that are received and sensed by the seismic sensors 58 include “up going” seismic waves that propagate to the sensors 58 after reflections at the subsurface, as well as “down going” seismic waves that are produced by reflections of the pressure waves 60 from an air-water boundary, or free surface 31.

The seismic sensors 58 generate signals (digital signals, for example), called “traces,” which indicate the acquired measurements of the pressure wavefield and particle motion. The traces are recorded and may be at least partially processed by a signal processing unit 23 that is deployed on the survey vessel 20, in accordance with some embodiments of the invention. For example, a particular seismic sensor 58 may provide a trace, which corresponds to a measure of a pressure wavefield by its hydrophone; and the sensor 58 may provide (depending on the particular embodiment of the invention) one or more traces that correspond to one or more components of particle motion.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a seismic data processing system that may be, for example, located on land or on the vessel 20. Thus, many variations are possible and are within the scope of the appended claims.

A towed marine seismic survey may have a spread of streamers 30 that are spaced apart in the crossline (y) direction, which means that the seismic sensors are rather sparsely spaced apart in the crossline direction, as compared to the inline (x) spacing of the seismic sensors. As such, the pressure wavefield may be relatively densely sampled in the inline (x) direction while being sparsely sampled in the crossline direction to such a degree that the sampled pressure wavefield may be aliased in the crossline direction. In other words, the pressure data acquired by the seismic sensors may not, in general, contain sufficient information to produce an unaliased construction (i.e., an unaliased continuous interpolation) of the pressure wavefield in the crossline direction.

In accordance with embodiments of the invention described herein, the generalized sampling expansion (GSE) theorem is used in the processing of acquired seismic data for purposes of constructing an unaliased, continuous representation of the pressure wavefield in the crossline direction. The GSE theorem is generally described in Papoulis, A., 1977, Generalized Sampling Expansion, IEEE Trans. Cir. Syst., Vol. 24, No. 11, pp. 652-654. According to the GSE theorem, a band-limited signal s(x) may be uniquely determined in terms of the samples (sampled at 1/m of the Nyquist wavenumber) of the responses of m linear systems that have s(x) as the input.

FIG. 1 is an illustration 100 of the GSE theorem-based scheme. A signal s(x) is filtered by a bank of n linear and independent filters 102₁, 102₂ . . . 102ₙ₋₁ and 102ₙ. The n filtered signals are sampled (as depicted by the switches 104) with a sampling rate that can be as low as 1/n the Nyquist rate of s(x). Such decimation generates n sequences (i.e., sequences s₁(x) to sₙ(x)) that are subject to aliasing up to order n.

The GSE theorem states that from the n filtered, decimated and aliased signals, it is possible to reconstruct the unaliased signal s(x). In other words, it is possible to determine n reconstruction filters 106₁, 106₂, 106ₙ₋₁ and 106ₙ that when applied to the sequences produce signals that when added together (as illustrated by the adder 107) produce an unaliased reconstruction of the s(x) signal.

The GSE theorem has many potential applications in seismic data interpolation. If n independent seismic measurements are modeled as the samples of the outputs of a set of independent filters applied to the same input signal, then those samples may be used to reconstruct the input signal up to a bandwidth as wide as n times the theoretical Nyquist wavenumber of the available measurements. Hence, the initial n measurements may be aliased up to a factor of n−1.

The crossline reconstruction of the unaliased pressure wavefield may be performed by applying the GSE theorem to measurements of a directional particle velocity sensor (V_{θ}) and pressure (P). Here, the directional particle velocity sensor is oriented in the crossline/depth plane, with a known elevation angle θ with respect to the vertical axis. Assuming a flat sea surface, the pressure P and the directional particle velocity V_{θ} measurements acquired by multi-component sensors towed at a depth z below the free surface (the water-air interface) may be described as follows:

$$\begin{matrix}P = 1 \cdot P = {H}_{1} ( {k}_{y} ) P , and & Eq . 1 \\ \begin{matrix}{V}_{θ} = {V}_{z} cos θ + {V}_{y} sin θ \\ = [ \frac{{k}_{z} cos θ}{ρ ω} \frac{( 1 + G )}{( 1 - G )} + \frac{{k}_{y} sin θ}{ρ ω} ] P = … \\ = [ \begin{matrix}\frac{cos θ \sqrt{\frac{{ω}^{2}}{{c}^{2}} - {k}_{x}^{2} - {k}_{y}^{2}}}{ρ ω} \frac{1 + {e}^{i 2 Z \sqrt{\frac{{ω}^{2}}{{c}^{2}} - {k}_{x}^{2} - {k}_{y}^{2}}}}{1 - {e}^{i 2 Z \sqrt{\frac{{ω}^{2}}{{c}^{2}} - {k}_{x}^{2} - {k}_{y}^{2}}}} + \\ \frac{{k}_{y} sin θ}{ρ ω}\end{matrix} ] P \\ = {H}_{2} ( {k}_{y} ) P\end{matrix} & Eq . 2\end{matrix}$$

where “V_{z}” represents the vertical component of the particle velocity vector, “V_{y}” represents the horizontal (cross-line) component of the particle velocity vector, “k_{z}” represents the vertical wavenumber, expanded as a function of horizontal wavenumbers (“kₓ” and “k_{y}”, in-line wavenumber and cross-line wavenumber, respectively) in the second term of Eq. 2; “ρ” represents the density of water; “ω” represents the temporal frequency; “G” represents the ghost operator, assuming a flat sea surface; “Z” represents the depth of the streamer (assumed to be constant); and “c” represents the wave propagation velocity in water.

As can be appreciated by one of skill in the art, that the above-disclosed system may be further generalized to a particle velocity sensor with a three-dimensional (3-D) orientation angle, described also by an azimuth angle in addition to the elevation θ in Eq. 2, and hence possibly also sensitive to variations in the in-line (x) direction.

The crossline reconstruction of the unaliased pressure wavefield may be performed by applying the GSE theorem to vertical particle velocity (V_{z}) and pressure (P) measurements. This corresponds to a particular case of the above system, with the directional sensor oriented vertically, and thus the elevation angle θ equals to 0. Assuming a flat sea surface, the pressure P and vertical particle velocity V_{z} measurements acquired by multi-component sensors towed at a depth z below the free surface (the water-air interface) may be described as follows:

$$\begin{matrix}P = 1 \cdot P = {H}_{1} ( {k}_{y} ) P , and & Eq . 3 \\ \begin{matrix}{V}_{z} = \frac{{k}_{z}}{ρ ω} \frac{( 1 + G )}{( 1 - G )} P \\ = \frac{\sqrt{\frac{{ω}^{2}}{{c}^{2}} - {k}_{x}^{2} - {k}_{y}^{2}}}{ρ ω} \frac{1 + {e}^{i 2 Z \sqrt{\frac{{ω}^{2}}{{c}^{2}} - {k}_{x}^{2} - {k}_{y}^{2}}}}{1 - {e}^{i 2 Z \sqrt{\frac{{ω}^{2}}{{c}^{2}} - {k}_{x}^{2} - {k}_{y}^{2}}}} P \\ = {H}_{2} ( {k}_{y} ) P\end{matrix} & Eq . 4\end{matrix}$$

where “k_{z}” represents the vertical wavenumber, expanded as a function of horizontal wavenumbers in the second term of Eq. 4; “ρ” represents the density of water; “ω” represents the temporal frequency; “G” represents the ghost operator, assuming a flat sea surface; “Z” represents the depth of the streamer (assumed to be constant); and “c” represents the wave propagation velocity in water.

The system of Eqs. 3 and 4 matches the GSE theorem illustration 100 of FIG. 1, where H₁(k_{y}) and H₂(k_{y}) are the linear independent filters 102. Thus, in accordance with embodiments of the invention described herein, the Vz measurement may be used for the purpose of the crossline interpolation of the pressure wavefield P, with the aim of reducing the aliasing impact and ideally to removing all the first order aliasing from the reconstructed pressure wavefield. An “unaliased” representation of a wavefield, used in the context of this application, means that the representation is substantially free of aliasing.

When the flat sea assumption holds the ghost operator is known, and the Vz component implicitly contains horizontal information related to the propagating and reflecting wavefields. The V_{z} and pressure P measurements may be used to reconstruct an unaliased crossline representation of the pressure wavefield for a rough sea surface, in accordance with other embodiments of the invention. It is noted that for a rough sea surface, a model for the rough sea surface may be used; or alternatively, the model described above for the flat sea surface may be used when the model is still expected to be a reasonable approximation.

In accordance with other embodiments of the invention, a system that is compliant with the GSE representation may be constructed, in which only pressure measurements that are acquired at more than one depth are used. More specifically, the pressure measurements may be acquired by a spread of towed seismic streamers in an over/under configuration. In the over/under configuration, the pressure signal is measured at two different depths, z₁ and Z₂, and may be described as follows:

$$\begin{matrix}P ( {z}_{1} ) = 1 \cdot p ( {z}_{1} ) = {H}_{1} ( {k}_{y} ) P ( {z}_{1} ) , and & Eq . 5 \\ \begin{matrix}P ( {z}_{2} ) = {e}^{i {k}_{z} Δ z} \frac{1 - G ( {z}_{2} )}{1 - G ( {z}_{1} )} P ( {z}_{1} ) \\ = {e}^{i {k}_{z} Δ z} \frac{1 - {e}^{i 2 {z}_{2} \sqrt{\frac{{ω}^{2}}{{c}^{2}} - {k}_{x}^{2} - {k}_{y}^{2}}}}{1 - {e}^{i 2 {z}_{1} \sqrt{\frac{{ω}^{2}}{{c}^{2}} - {k}_{x}^{2} - {k}_{y}^{2}}}} P ( {z}_{1} ) \\ = {H}_{2} ( {k}_{y} ) P ( {z}_{1} ) ,\end{matrix} & Eq . 6\end{matrix}$$

where “z¹,” “Z₂” and “Δz” represent the depths of the two streamers and the difference of these depths, respectively.

Thus, equations 1 and 2 (V₀ and P measurements), or 3 and 4 (V_{z} and P measurements); or 5 and 6 (P measurements at different depths), may be applied to define a GSE compliant system that may then be solved (as further described below) for the substantially unaliased reconstruction of the pressure wavefield. The basic feature of all three systems is that all of them have the capability of extracting to the horizontal dimension the information of measurements that describe the vertical variations of the pressure wavefield, thereby adding significant value to both multi-component and over/under seismic acquisitions.

A particular case of Eqs. 1 and 2 where the elevation angle θ equals to 90 degrees (or 270 degrees) is not considered herein, as in this case the measurements described in Eqs. 1 and 2 do not contain any information related to vertical variations of the pressure wavefield and corresponds to the P and V_{y} wavefields, respectively. This particular case is covered, for example, by, U.K. Patent Application No. 0714404.4, entitled, “METHOD OF REPRESENTING SIGNALS,” (Attorney Docket No. 57.0730), filed on Jun. 13, 2007, and is hereby incorporated by reference in its entirety, that discloses a matching pursuit technique to reconstruct a pressure wavefield from the system that is defined by Eqs. 1 and 2 when the elevation angle θ equals to 90 degrees (or 270 degrees).

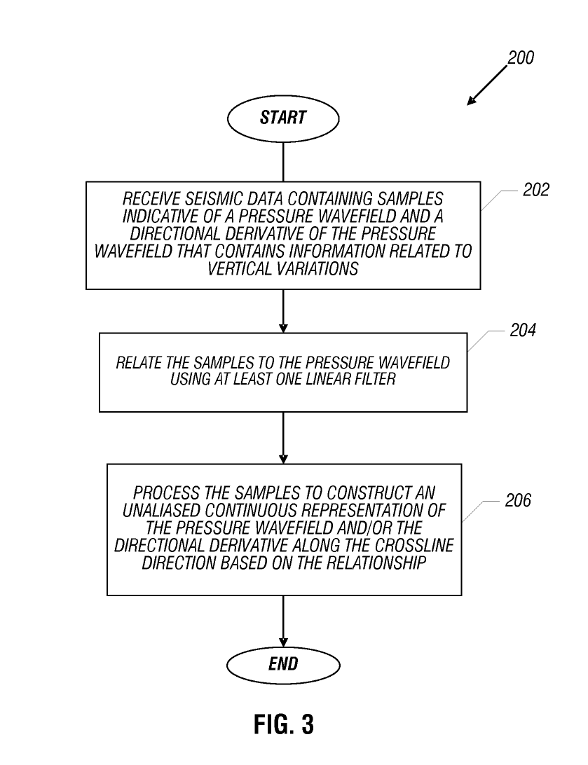

To summarize, FIG. 3 depicts a technique 200 that may be used, in general, to construct a substantially unaliased continuous representation of a pressure wavefield or directional derivative (such as the vertical particle velocity) of the pressure wavefield in an undersampled direction (such as the crossline direction, for example) in accordance with some embodiments of the invention. Pursuant to the technique 200, seismic data are received (block 202), which contain samples that are indicative of a pressure wavefield and a directional derivative of the pressure wavefield that contains information related to vertical variations. The samples are related to the pressure wavefield and/or to the directional derivative of the pressure wavefield using at least one linear filter, pursuant to block 204. Pursuant to block 206, based on this relationship, the samples are processed to construct an unaliased continuous representation of the pressure wavefield and/or the directional derivative along the undersampled direction.

It is noted that the techniques described herein are not limited solely to samples that indicate vertical variations in the pressure wavefield, as other supplemental measurements may be used to enhance the crossline reconstruction of the pressure wavefield. For example, a multi-component streamer may acquire data indicative of the horizontal (cross-line) component Vy of the particle velocities, in addition to the P and Vz measurements. For the V_{y} measurements, the systems set forth in the equations above may be easily extended to a larger system involving P, V_{z} and V_{y} measurements, which is still compliant with the GSE representation; and hence, this larger system allows the reconstruction of an event decimated up to one third of its natural Nyquist wavenumber.

For purposes of simplifying the following discussion, only the case of a two component acquisition, measuring P and Vz, with the assumption of flat sea surface is considered. Therefore, the following is an example showing how the system that is set forth in Eqs. 3 and 4 may be solved. It is noted that the other systems may be solved using similar techniques. For purposes of example, two solutions to the system in Eqs. 3 and 4 are described below. The first solution is data independent, and the second solution is data dependent.

Regarding the first data independent solution, a generic solution set forth by Brown, J. L., 1981, Multi-Channel Sampling of Low-Pass Signals, IEEE Trans. Circ. Syst., Vol. 28, No. 2, pp. 101-106, may be used to determine the direct reconstruction filters and therefore, the interpolated P wavefield in the crossline direction in a spatial bandwidth between −1/ΔY and 1/ΔY, where “ΔY” is the sampling step in cross-line direction. The input measurements are P and Vz, subject to first order aliasing in the acquired bandwidth, between −½ΔY and ½ΔY. The forward system matrix A(ky) is defined as follows:

$$A ( {k}_{y} ) = ( \begin{matrix}1 & {H}_{2} ( {k}_{y} ) \\ 1 & {H}_{2} ( {k}_{y} + 1 / Δ Y )\end{matrix} ) . \qquad Eq . 7$$

For cross-line horizontal wavenumbers ky in the subinterval [−1/ΔY, 0], the reconstruction filters may be computed from the inverse of A(ky) as follows:

$$\begin{matrix}{I}_{1} ( {k}_{y} + ( m - 1 ) / Δ Y ) = Δ Y \cdot {b}_{1 m} ( {k}_{y} ) , and & Eq . 8 \\ {I}_{2} ( {k}_{y} + ( m - 1 ) / Δ Y ) = Δ Y \cdot {b}_{2 m} ( {k}_{y} ) , & Eq . 9\end{matrix}$$

where “bᵢₘ(k_{y})” represents the [i,m]th element of the inverse of A(ky); and m is either one or two.

The terms of the inverse matrix A⁻¹(k_{y}) effectively determine the reconstruction filters, I1 and I2, on the full interval [−1/ΔY, 1/ΔY]. Those filters are acting according to the scheme in FIG. 1, that is applied to multi-channel datasets modeled according to the equations that are set forth above.

The reconstruction filters Ii(ky) may be applied to the aliased measured pressure and vertical particle velocity wavefields (or to pressure wavefield from upper and lower streamers) in the crossline horizontal wavenumber domain directly, provided these aliased wavefields are periodically extended to the domain (−1/ΔY, 1/ΔY). An inverse Fourier transform may be performed over the crossline horizontal wavenumber to produce the de-aliased pressure wavefield.

This approach implicitly assumes that the sampling is regular and that infinite samples are available. A method to adapt this approach to a more realistic scenario, having a limited number of samples and irregular sampling intervals may be derived from the techniques that are described in U.S. patent application Ser. No. ______, entitled, “DEGHOSTING AND RECONSTRUCTING A SEISMIC WAVEFIELD,” (Attorney Docket No. 53.0106), which is concurrently filed herewith and is hereby incorporated by reference in its entirety.

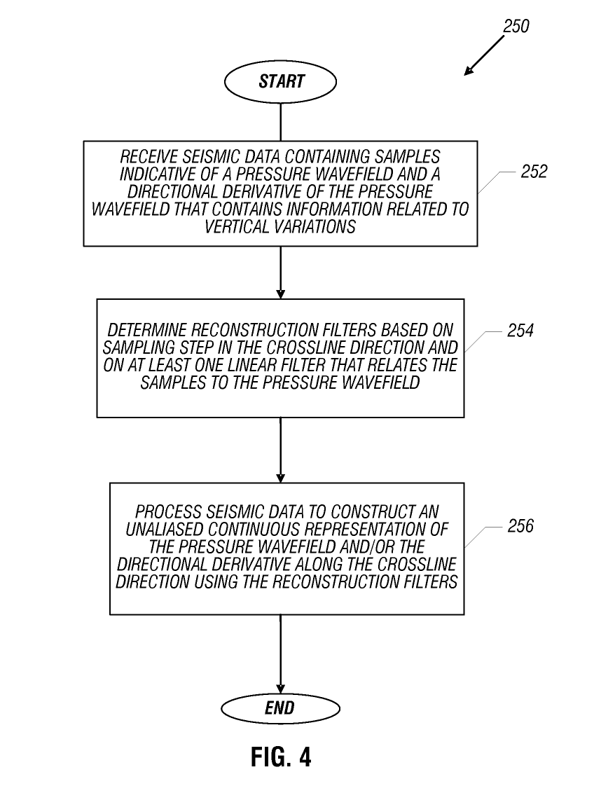

To summarize, in accordance with embodiments of the invention, a technique 250, which is depicted in FIG. 4, may be used for purposes of constructing a continuous representation of a pressure wavefield and/or a directional derivative of the pressure wavefield. Pursuant to the technique 250, seismic data are received, pursuant to block 252, which contain samples that are indicative of a pressure wavefield and a directional derivative of the pressure wavefield that contains information related to vertical variations. Pursuant to block 254, reconstruction filters are determined. The determination of the reconstruction filters is based on at least one linear filter that relates the samples to the pressure wavefield and a sampling step in the undersampled direction. The seismic data are processed (block 256) to construct a substantially unaliased representation of the pressure wavefield and/or the directional derivative in the undersampled direction, based on the reconstruction filters.

In accordance with other embodiments of the invention, a data dependent technique may be used to solve for the substantially unaliased representation of the pressure wavefield along the crossline direction. As a non-limiting example, a Generalized Matching Pursuit may be used, as generally described in U.S. patent application Ser. No. ______, entitled, “RECONSTRUCTING A SEISMIC WAVEFIELD,” which is concurrently filed herewith and is hereby incorporated by reference (Attorney Docket No. 53.0104).

The ideal spectra of two measurements, before decimation, in the wavenumber domain is described as follows:

S₁(k)=H₁(k_{y})S(k)=S(k)(Re(H₁(k_{y}))+j Im(H₂(k_{y}))), and Eq. 10

S₂(k)=H₂(k_{y})S(k)=S(k)(Re(H₂(k_{y}))+j Im(H₂(k_{y}))), Eq. 11

where “Re(x)” and “Im(x)” represents the real and imaginary parts, respectively, of the argument x.

The unknown signal s(y) may be modeled at the sampled positions, yₙ, as a linear combination of a set of complex exponentials, used as basis functions, as described below:

$$s ( {y}_{n} ) = {\sum }_{p} {A}_{p} exp ( i ( {k}_{p} {y}_{n} + {ψ}_{p} ) ) . \qquad Eq . 12$$

In Eq. 12, the p-th basis function is defined by three parameters Aₚ, ψₚ and kₚ, which describe the amplitude, the phase and the wavenumber, respectively, of the complex exponentials. The basis functions that describe the signal are iteratively estimated.

Although the basis functions are described herein by way of example as being complex exponentials, other basis functions (e.g., cosines, damped exponentials, chirplets, wavelets, curvelets, seislets, etc.) may be used in accordance with other embodiments of the invention.

With respect to Eqs. 10 and 11, the two measured signals may be described using the same set of basis functions, by applying the filters H₁(k) and H₂(k) of the forward model to them, as described below:

$$\begin{matrix}{s}_{1} ( {y}_{n} ) = {\sum }_{p} {A}_{p} exp ( i ( {k}_{p} {y}_{n} + {ψ}_{p} ) ) {H}_{1} ( {k}_{p} ) , and & Eq . 13 \\ {s}_{2} ( {y}_{n} ) = {\sum }_{p} {A}_{p} exp ( i ( {k}_{p} {y}_{n} + {ψ}_{p} ) ) {H}_{2} ( {k}_{p} ) . & Eq . 14\end{matrix}$$

It is noted that in Eqs. 13 and 14 the unknowns are the same as the unknowns in Eq. 14, and that the forward filters are not subject to aliasing when they are applied to the basis functions.

With the iterative matching pursuit approach, the basis functions that best match the inputs s₁(yₙ) and S₂(yₙ) to the desired output s(y) at any desired position are determined.

At the j-th iteration, the best parameters set └Aⱼ, ψⱼ, kⱼ┘ is selected by minimizing the residual with respect to the two measurements, which may be weighted in accordance with other embodiments of the invention.

If “res[s₁(yₙ)]ⱼ₋₁”, and “res [s₂(yₙ)]ⱼ₋₁” are the residuals at iteration j−1, then the following relationships apply:

$$\begin{matrix}{res [ {s}_{1} ( {y}_{n} ) ]}_{j - 1} = {s}_{1} ( {y}_{n} ) - {\sum }_{p = 1}^{j - 1} {A}_{p} exp ( i ( {k}_{p} {y}_{n} + {ψ}_{p} ) ) {H}_{1} ( {k}_{p} ) , \\ and & Eq . 15 \\ {res [ {s}_{2} ( {y}_{n} ) ]}_{j - 1} = {s}_{2} ( {y}_{n} ) - {\sum }_{p = 1}^{j - 1} {A}_{p} exp ( i ( {k}_{p} {y}_{n} + {ψ}_{p} ) ) {H}_{2} ( {k}_{p} ) . & Eq . 16\end{matrix}$$

With a least-squares approach, the best matching parameters set, at iteration j, is the set that minimizes the energy of a cost function, as follows:

$$[ {A}_{j} , {ψ}_{j} , {k}_{j} ] = {arg min}_{[ A , ψ , k ]} [ \begin{matrix}{\sum }_{n} {\vert \begin{matrix}{res [ {s}_{1} ( {y}_{n} ) ]}_{j - 1} - \\ A exp ( i ( {ky}_{n} + ψ ) ) {H}_{1} ( k )\end{matrix} \vert}^{2} + \\ {\vert \begin{matrix}{res [ {s}_{2} ( {y}_{n} ) ]}_{j - 1} - \\ A exp ( i ( {ky}_{n} + ψ ) ) {H}_{2} ( k )\end{matrix} \vert}^{2}\end{matrix} ] . \qquad Eq . 17$$

Some parametric weights may be used in Eq. 12 to balance the different signal-to-noise ratio (SNR) in the two input measurements.

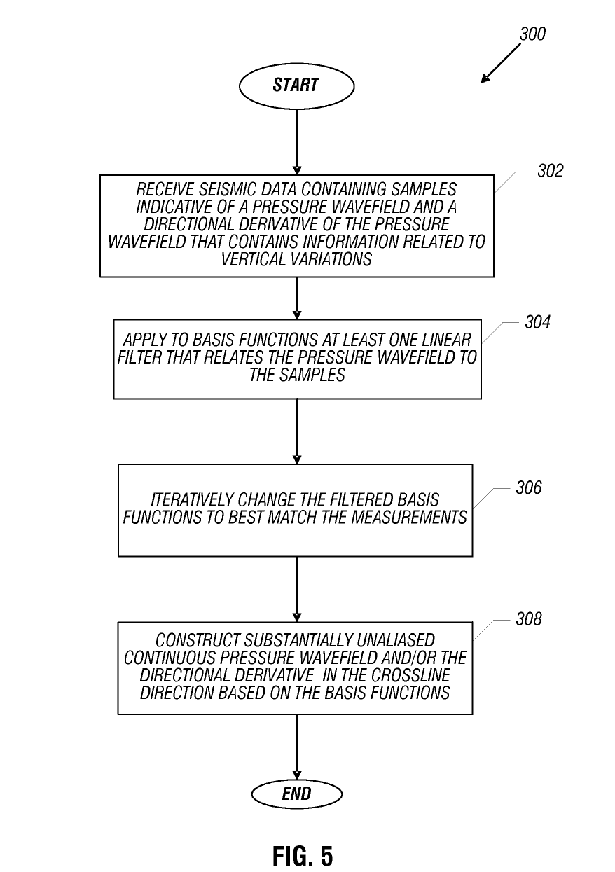

The optimal solution related to each wavenumber is described in U.S. patent application Ser. No. ______, entitled, “RECONSTRUCTING A SEISMIC WAVEFIELD” (Attorney Docket No. 53.0104). To summarize, in accordance with embodiments of the invention, a technique 300 that is depicted in FIG. 5 may be used for purposes of determining a substantially unaliased pressure wavefield and/or directional derivative of the pressure wavefield along the crossline direction. Pursuant to the technique 300, seismic data are received (block 302), which contain samples that are indicative of a pressure wavefield and a directional derivative of the pressure wavefield that contains information related to vertical variations. Pursuant to block 304, the samples are related to the continuous pressure wavefield by applying at least one linear filter to a set of basis functions. The basis functions are iteratively modified, pursuant to block 306, until basis functions that best match the measured samples are determined. The substantially unaliased pressure wavefield and/or directional derivative may then be constructed from the basis functions, pursuant to block 308.

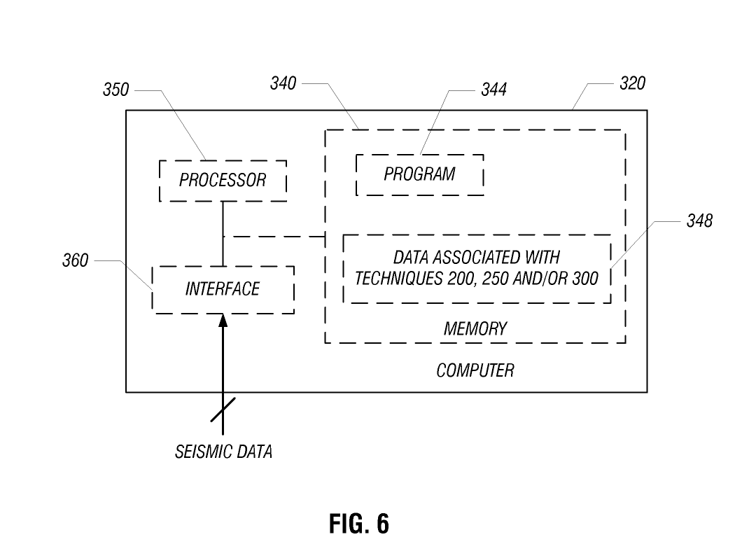

Referring to FIG. 6, in accordance with some embodiments of the invention, a data processing system 320 contains a processor 350 that processes acquired seismic data to perform at least some parts of one or more of the techniques that are disclosed herein for such purposes (as non-limiting examples) of constructing a substantially unaliased crossline representation of a pressure wavefield along the crossline direction; determining reconstruction filters; determining basis functions; evaluating cost functions; modeling a GSE compliant system; relating samples to the pressure wavefield using two or more linear filters; etc.

In accordance with some embodiments of the invention, the processor 350 may be formed from one or more microprocessors and/or microcontrollers. As non-limiting examples, the processor 350 may be located on a streamer 30 (see FIG. 1), located on the vessel 20 (see FIG. 1) or located at a land-based processing facility, depending on the particular embodiment of the invention.

The processor 350 may be coupled to a communication interface 360 for purposes of receiving such data as the acquired seismic data (data indicative of P, V_{z} and V_{y} measurements, as non-limiting examples). As examples, the communication interface 360 may be a Universal Serial Bus (USB) interface, a network interface, a removable media (such as a flash card, CD-ROM, etc.) interface or a magnetic storage interface (IDE or SCSI interfaces, as examples). Thus, the communication interface 360 may take on numerous forms, depending on the particular embodiment of the invention.

In accordance with some embodiments of the invention, the communication interface 360 may be coupled to a memory 340 of the system 320 and may store, for example, various input and/or output datasets involved in the determination of the above-described pressure wavefield reconstruction; reconstruction filters; basis functions; cost function evaluations; etc. The memory 340 may store program instructions 344, which when executed by the processor 350, may cause the processor 350 to perform various tasks of one or more of the techniques and systems that are disclosed herein, such as the techniques 200, 250 and/or 300; and the system 320 may display preliminary, intermediate and/or final results obtained via the technique(s)/system(s) on a display (not shown in FIG. 6) of the system 320, in accordance with some embodiments of the invention.

Other variations are contemplated and are within the scope of the appended claims. For example, the techniques and system that are disclosed herein may be applied to construct a substantially unaliased representation of a pressure wavefield based on measurements acquired by sensors disposed in sensor cables other than streamers. As non-limiting examples, these other sensor cables may be seabed or land-based sensor cables.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
receiving seismic data acquired in a seismic survey, the survey having an associated undersampled direction and the seismic data containing samples indicative of a pressure wavefield and a directional derivative of the pressure wavefield that contains information related to vertical variations;
relating the samples to the pressure wavefield or the directional derivative of the pressure wavefield using at least one linear filter; and
based on the relationship, constructing a substantially unaliased continuous representation of the pressure wavefield or the directional derivative of the pressure wavefield along the undersampled direction.

2. The method of claim 1, wherein the directional derivative comprises a vertical particle velocity.

3. The method of claim 1, wherein the samples comprise samples of the pressure wavefield and samples of a vertical component of a particle velocity wavefield.

4. The method of claim 1, wherein the samples comprise samples of the pressure wavefield at different depths from streamers towed at the different depths.

5. The method of claim 1, wherein the act of relating the samples to the pressure wavefield comprises applying a generalized sampling expansion.

6. The method of claim 1, wherein the measurements are affected by spatial aliasing due to sampling.

7. The method of claim 1, wherein the act of constructing the unaliased continuous representation comprises determining reconstruction filters that are independent of the samples.

8. The method of claim 7, wherein the act of determining comprises basing the reconstruction filters at least in part on said one linear filter and a crossline sampling interval.

9. The method of claim 1, wherein the act of constructing the substantially unaliased continuous representation of the pressure wavefield comprises modeling the unaliased continuous representation as a linear combination of said at least one linear filter and basis functions.

10. The method of claim 8, wherein the act of constructing further comprises applying a generalized matching pursuit technique.

11. The method of claim 1, further comprising:
acquiring the seismic data using a seabed array, a land-based array or a towed array.

12. The method of claim 1, wherein said at least one linear filter is adapted to accommodate a rough sea surface.

13. The method of claim 1, wherein said at least one linear filter is adapted to act in the undersampled direction.

14. The method of claim 1, wherein the samples comprise samples acquired in a regularly or an irregularly spaced sample grid.

15. A system comprising:
an interface to receive seismic data acquired in a seismic survey, the survey having an associated undersampled direction and the seismic data containing samples indicative of a pressure wavefield and a directional derivative of the pressure wavefield that contains information related to vertical variations; and
a processor to process the seismic data to, based on a relationship of the samples to the pressure wavefield or to the directional derivative of the pressure wavefield using at least one linear filter, construct a substantially unaliased continuous representation of the pressure wavefield or the directional derivative along the undersampled direction.

16. The system of claim 15, wherein the directional derivative comprises a vertical particle velocity.

17. The system of claim 15, wherein the samples comprise samples of the pressure wavefield and samples of a vertical component of a particle velocity wavefield.

18. The system of claim 15, wherein the samples comprise samples of the pressure wavefield at different depths from streamers towed at the different depths.

19. The system of claim 15, wherein the processor applies a generalized sampling expansion to relate the samples to the pressure wavefield.

20. The system of claim 15 wherein the processor determines reconstruction filters to construct the continuous representation independently of the samples.

21. The system of claim 15, wherein the processor processes the seismic data to model the unaliased continuous representation as a linear combination of said at least one linear filter and basis functions.

22. The system of claim 15, further comprising:
an array of seismic sensors to acquire the seismic data, comprising a seabed-based array, a land-based array or a streamer array.

23. The system of claim 22, further comprising:
a vessel to tow the array.

24. The system of claim 22, wherein the array comprises an array of towed streamers arranged in an over/under spread.

25. The system of claim 15, wherein the processor is adapted to apply a generalized matching pursuit technique.
